(19) United States
(12) Patent Application Publication
(10) Pub. No.: US 2022/0148120 A1
(43) Pub. Date: May 12, 2022

(54) Quality Assurance for Unattended Computer Vision Counting

(71) Applicant: United States of America, as represented by the Director, National Geospatial-Intelligence Agency, Springfield, VA (US)

(72) Inventors: Michael A. Starr, Charlottesville, VA (US); Alexander J. Mulia, Crozet, VA (US)

(73) Assignee: United States of America, as represented by the Director, National Geospatial-Intelligence Agency, Springfield, VA (US)

(21) Appl. No.: 17/521,056

(22) Filed: Nov. 8, 2021

Related U.S. Application Data
(60) Provisional application No. 63/111,117, filed on Nov. 9, 2020.

(51) Int. Cl. G06T 1/00; G06T 7/70

(52) U.S. Cl. CPC G06T 1/0014; G06T 2207/30242; G06T 7/70

(57) ABSTRACT

Systems and methods for performing quality assurance assessments for unattended computer vision counting tools are presented. Classification information is used to generate coefficients for error equations. Recursive digital filters are used to train and update these coefficients. These coefficients are used to determine object count uncertainty ranges for an area of interest.

### STATEMENT OF GOVERNMENT INTEREST

The invention described herein was made by employees of the United States Government and may be manufactured and used by or for the Government for Government purposes without payment of any royalties.

### BACKGROUND

Object counting in images is vital to a number of fields, from counting cells in microscopic images, to counting cars on a highway to estimate traffic flow. The accuracy of the conclusions that we draw from these object counts (spread of cancerous cells or whether or not to add a new lane to an existing highway) is dependent on the accuracy of the object counts. With the rise of misinformation campaigns, ensuring the accuracy of data analysis tools, such as object counting tools, is even more vital.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

The present application is directed to systems and methods for assessing and acting on uncertainty in automated object counts generated by Computer Vision Tools (CVTs). These systems and methods are independent of the inner workings of the CVT and, after training, only require the object count generated by the CVT. This makes the systems and methods described in this application especially useful for assessing “black box” CVTs. The systems and methods described comprise: in a training mode, receiving the object count generated by the CVT, the true object count, the number of objects not counted by the CVT (false negatives), and the number of objects counted incorrectly by the CVT (false positives) for a plurality of images; generating, based on the data received corresponding to the plurality of images, four coefficients; generating, using the four coefficients, two error estimates, and adjusted object count, upper and lower limits bracketing the adjusted object count based on a percent confidence interval, and an optional status signal; in a non-training mode, receiving the object count generated by the CVT and generating, using the coefficients generated in the training mode, an adjusted object count, upper and lower limits bracketing the adjusted object count based on a percent confidence interval, and an optional status signal.

Multiple embodiments are described below.

Many of the attendant features will be more readily appreciated by reference to the following detailed description and the accompanying drawings.

### DESCRIPTION OF THE DRAWINGS

The present description will be better understood from the following detailed description read in light of the accompanying drawings, wherein:

FIG. 1 is an illustration of one embodiment of the systems and methods disclosed;

FIG. 2 is an illustration of a process utilizing the status signal described below;

FIG. 3 is an illustration of an exemplary computing-based device.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples. Further, various illustrated or described portions of processes may be re-ordered or executed in parallel in various different embodiments.

As used herein, the term “image” refers to an input to a Computer Vision Tool (CVT) where the input comprises sufficient data for the CVT to quantify the number of objects of a given class contained in the input. Examples of images include, but are not limited to: photographs; frames comprising video; point clouds; one or both of a pair of stereo images; synthetic or computer-generated images; medical images such as X-rays, magnetic resonance images, and others; outputs of radar, lidar, or sonar systems; satellite imagery; infrared, ultraviolet, and hyperspectral images; and any other similar representation of an environment known in the art. Further, the term Area of Interest (AOI) means the portion or portions of one or more images wherein the number of a category of items is counted.

References to labeled images refer to: images that have been manually labeled by a human being; images that have been labeled by an automated system where the accuracy of the labels was verified by a human being; images that were synthetically generated to contain a known number objects to be labeled; any other type of labeled imagery known in the art where the labeling is known to be accurate.

While the description provided may refer to a 90 percent confidence interval, it is understood that this interval is used as an example and not as a limitation. The percent confidence interval can be set to any value, and may be set by a user, a third party, adjusted automatically based on user or automated inputs, or by any other means known in the art, without departing from the scope of the specification.

The present application is directed to systems and methods for assessing and acting on uncertainty in automated object counts generated by CVTs. These systems and methods are independent of the inner workings of the CVT. During training, only data related to object counts is required and, after training, only the object count generated by the CVT is required. This makes the systems and methods described in this application especially useful for assessing “black box” CVTs, competitor CVTs, or CVTs of potential partners who may be unwilling to accept the risks associated with granting access to their proprietary technologies.

In addition, because no imagery data is required for analysis, the systems and methods are especially useful in environments with degraded communications (e.g., low or intermittent bandwidth) or in environments where persistent communication with the CVT is not possible or not desired.

The systems and methods described comprise: in a training mode, receiving the object count generated by the CVT, the true object count, the number of objects not counted by the CVT (false negatives), and the number of objects counted incorrectly by the CVT (false positives) for a plurality of images; generating, based on the data received corresponding to the plurality of images, four coefficients; generating, using the four coefficients, two error estimates, and adjusted object count, upper and lower limits bracketing the adjusted object count based on a percent confidence interval, and an optional status signal; in a non-training mode, receiving the object count generated by the CVT and generating, using the coefficients generated in the training mode, an adjusted object count, upper and lower limits bracketing the adjusted object count based on a percent confidence interval, and an optional status signal.

The systems and processes disclosed are described below in reference to one embodiment, the Computer Vision Count Assessment Tool (CV CAT). However, this description is merely exemplary and other embodiments of the systems and processes disclosed may be used without departing from the scope of the specification.

The CV CAT estimates the difference between the CVT's object count and the ground truth; we define this difference as the real error of the CVT at a given AOI. The CV CAT works by estimating the average of this real error, referred to as the mean bias estimator (MBE). The CV CAT also estimates the standard deviation of this real error called the standard deviation estimator (SDE). The CV CAT adds the MBE to the CVT count to generate the statistically adjusted machine count (SAMC).

Generally, the CV CAT models two forms of uncertainty. One of these forms of uncertainty is associated with the SDE, which accounts for statistical variations in the SAMC. We call this uncertainty the random error, and the CV CAT quantifies this uncertainty in the manner discussed below. Further, there is a second level of uncertainty in how well the CV CAT estimates the mean of the real error with the MBE. This is a second form of uncertainty and is quantified below by using the margin of error (MOE) of the MBE.

After the CV CAT combines both of these forms of uncertainty, it provides an upper limit and lower limit to bracket the SAMC. The range of counts between this lower limit and the upper limit defines the 90 percentile error reported by the CV CAT. This means that 90 percent of the time, the ground truth count will reside in between these two limits.

Variable labeling conventions used in this application are listed below:
The letter n represents a count.
A variable with a line accent represents a mean (n̅).
A variable with a caret accent represents a sampled mean (\hat{n}).
The Greek letter σ represents a standard deviation.
The letter S represents a sample standard deviation.
The term σ² represents a variance.
The term S² represents a sampled variance.
The Greek letter Δ represents a difference.

Below are definitions of several quantities that are referenced throughout this application:
nₜ=the total number of images processed over a given AOI including both labeled and non-labeled images.
i=the index of all images of an AOI. This index covers both labeled and non-labeled images.
n_{dci}=the number of objects counted in a given category by a computer vision tool (CVT) in a single image with index i, for a given AOI.
n_{hci}=the number of objects in a single image with index i, for a given AOI and category. We treat this number as the ground truth.
nₛ=the total number of labeled images processed for a given AOI and category. This term is used to create a sample space for calculating statistical count errors during the training mode of the Computer Vision Count Assessment Tool (CV CAT).
j=the index in the number of images used to train the CV CAT represented by nₛ.
n_{fpi}=the number of false positives, on a given image with index i, for a given AOI and category. This error occurs when the CVT falsely classifies an object as a member of the desired category. This error also occurs when the CVT counts an object outside of the AOI.
n_{mdi}=the number of missed detections (false negatives), on a given image with index i, for a given scene and category. This error occurs when the CVT fails to detect or properly classify an object in an AOI. Missed detections also occur when the position of a scene moves too much from image to image and alignment of the object is temporarily outside the AOI.
nₛₛ=the number of labeled images processed since the start or restart of a training mode.

There are three assumptions which impact how the CV CAT can be used. In general, these assumptions are: 1) the ratio of the missed detections to ground truth counts at an AOI are nominally constant over eight to 22 consecutive images; 2) the false positives at an AOI are nominally constant over eight to 22 consecutive images; and 3) the CVT average object counting error is nominally less than 40 percent.

Error Equations

In training mode, all four quantities n_{hci}, n_{dci}, n_{mdi}, and n_{fpi} are input into the CV CAT. However, in non-training mode, only the machine count n_{dci} is needed.

The two variables n_{hci} and n_{dci} are independent deterministic variables. The CV CAT does not average, perform any statistical sampling, or filter n_{hci} and n_{dci}. Since n_{dci} is a deterministic variable, the response of the CV CAT to changes in n_{dci} is instantaneous. Likewise, since n_{dci} is deterministic, the CV CAT can accurately calculate count uncertainties at a given AOI even when there is a large variation in machine count.

The two independent random variables that are input into the CV CAT are n_{mdi} and n_{fpi}. Internally, the CV CAT does not process n_{mdi} directly but instead processes the ratio of n_{mdi} to n_{hci}. By processing this ratio and n_{fpi}, instead of n_{mdi} and n_{fpi}, the CV CAT conducts stochastic signal processing on two well-behaved, slowly changing random variables, which makes the CV CAT robust.

In training mode, the CV CAT performs stochastic signal processing on n_{fpi} and the ratio of n_{mdi} to n_{hci} in order to update the four coefficients of the two major error equations discussed below. After training on the data corresponding to each labeled image, the CV CAT freezes the four coefficients used in the two major error coefficients. In non-training mode, the CV CAT uses the two major error equations with their four coefficients frozen to the values updated by the last labeled image.

The four quantities that are input into the CV CAT in training mode are related to each other through the relations shown in Equation 1 below:

n_{hci}≈n_{mdi}+n_{dci}−n_{fpi} 1)

If we rearrange Equation 1, we can define a term we call the real error, which is the ground truth count minus the count determined by the CVT. The real error is defined as follows:

(real error)=nᵣₑᵢ=n_{hci}−n_{dci}−n_{mdi}−n_{fpi} 2)

Equation 2 shows that the real error is a function of two random variables, n_{mdi} and n_{fpi}. As discussed above, the random variable n_{fpi} has a relatively constant mean with modest variations. But the random variable n_{mdi} is highly dependent on the ground truth count and can vary rapidly. Equation 2 is not very useful as stated above. In the next few paragraphs, we will derive an equation to replace Equation 2 that depends only on the two relatively constant random variables n_{fpi} and m_{dhi} and the deterministic variable n_{dci}.

Equation 3 defines the ratio of missed detections to human counts at the i^{th} image as follows:

$${m}_{dhi} = \frac{{n}_{mdi}}{{n}_{hci}} \qquad 3 )$$

The CV CAT models the missed detections n_{mdi} as a linear function of the deterministic variable n_{hci}. This function is a linear equation with a slope of m_{dhi} that is also a random variable. A simple restatement of Equation 3 illustrates this and is shown below:

n_{mdi}=m_{dhi}*n_{hci} 4)

We can remove the random variable n_{mdi} in Equation 2 by substituting for it with the right side of Equation 4. The result of this substitution is shown below:

(real error)=nᵣₑᵢ=m_{dhi}*n_{hci}−n_{fpi} 5)

Equation 5 is an improvement over Equation 2 since Equation 5 defines the real error in terms of two random variables with relatively constant means m_{dhi} and n_{fpi}. However, the ground truth count, n_{hci}, term in Equation 5 is only available when images are labeled. We need an error equation that can work in both training mode and non-training mode.

If we take the right side of Equation 4 and use it to replace the term n_{mdi} in Equation 1, we can solve the resulting equation for n_{hci} to get the following equation:

$${n}_{hci} = \frac{( {n}_{dci} - {n}_{fpi} )}{( 1 - {m}_{dhi} )} \qquad 6 )$$

If we take the right side of Equation 6 and substitute it for n_{hci} in Equation 5 we get the following equation for the real error:

$$( real error ) = {n}_{hei} = \frac{( {m}_{dhi} )}{( 1 - {m}_{dhi} )} {n}_{dci} - \frac{1}{( 1 - {m}_{dhi} )} {n}_{fpi} \qquad 7 )$$

Equation 7 gives a function that defines the real error in terms of two mildly fluctuating random variables m_{dhi} and n_{fpi}, and one determinist variable n_{dci}. This deterministic variable is present in training mode and non-training mode. Equation 7 is a linear equation of the CVT count, n_{dci}. We can rewrite Equation 7 in the slope-intercept form of a linear equation as follows:

(real error)=nᵣₑᵢ=mᵣₑᵢ*n_{dci}−bᵣₑᵢ 8)

Where the real error slope is defined as follows:

$${m}_{rei} = \frac{{m}_{dhi}}{( 1 - {m}_{dhi} )} ≡ slope \qquad 9 )$$

The real error y-intercept is defined as follows:

$${b}_{rei} = \frac{- {n}_{fpi}}{( 1 - {m}_{dhi} )} ≡ intercept \qquad 10 )$$

The four coefficients that drive the two major error equations of the CV CAT are the sampled mean and sampled standard deviation of the slope and y-intercept represented by Equation 9 and Equation 10.

Equations 9 and 10 can only be used in training mode because the variable m_{dhi} and the variable n_{fpi} are only available from labeled imagery. Note m_{dhi} is needed to construct mᵣₑᵢ.

To make Equation 8 useful in non-training mode, we apply the sampled mean operator to it. We then use the associative and distributive properties of the operator to create an equation for calculating the mean of the real error as follows:

\hat{n}ᵣₑᵢ=\hat{m}ᵣₑᵢ*n_{dci}−\hat{b}ᵣₑᵢ 11)

Equation 11 represents the slow-moving correlated average called the mean bias error (MBE).

MBEᵢ=\hat{n}ᵣₑᵢ 12)

The slope, \hat{m}ᵣₑᵢ, and y-intercept, \hat{b}ᵣₑᵢ, in Equation 11 are the first and second coefficients that the CV CAT updates in training mode. The two coefficients are restated below as C₁ and C₂:

C₁=\hat{m}ᵣₑᵢ≡ [symbol] 13)

C₂=\hat{b}ᵣₑᵢ≡ [symbol] 14)

Both of the coefficients listed above are sampled means, and they are updated in the training mode of the CV CAT.

Equations 11 and 12 give us an equation for estimating the MBE of the real error. We can use the MBE of Equation 12 to statistically improve the machine count n_{dci}. If we use the right side of Equation 11 to replace nᵣₑᵢ on the left side of Equation 2 and solve the remaining equation for n_{hci}, what remains is the Statistically Adjusted Machine Count (SAMC). The SAMCᵢ is not equal to the ground truth count, n_{hci}, because we approximated the real error with the MBE. Equation 15 is an approximation of the ground truth count:

SAMCᵢ=n_{dci}+\hat{n}ᵣₑᵢ≈n_{hci} 15)

The CV CAT uses the SAMCᵢ in Equation 15 above as the center of its estimated count uncertainty interval. The CV CAT calculates the upper and lower limits of the count uncertainty interval centered on the SAMCᵢ point by estimating the statistical variation above and below the SAMCᵢ.

Estimating Uncertainties

The CV CAT models two forms of uncertainty. One of these forms of uncertainty is associated with the Standard Deviation Estimator (SDE), which accounts for statistical variations centered about the SAMC. We call this uncertainty the random error, and the CV CAT quantifies this uncertainty in the manner discussed below. Further, there is a second level of uncertainty in how well the CV CAT estimates the mean of the real error. This is a second form of uncertainty and is quantified below by using the Margin of Error (MOE) of the MBEᵢ.

After the CV CAT combines both of these forms of uncertainty, it provides an upper limit and lower limit to bracket the SAMC. The range of counts between this lower limit and the upper limit defines the percentile error reported by the CV CAT.

Obtaining the Standard Deviation Estimator

As a first step to estimating the random error, we attempt to estimate the standard deviation.

To build an equation or model that would estimate the standard deviation of each count, we applied a sampled variance operator to Equation 8. In applying the variance operator, we temporarily made the following two approximations: (1) the random variables are normal, and (2) the random variables are independent. Using the associative and distributive properties of the operator we derived the following equation for the variance of the real error count:

S²ᵣₑᵢ=Sₘᵣₑᵢ²*n_{dci}²+S_{brei}² 16)

Here, Sₘᵣₑᵢ² is the sampled variance of the slope mᵣₑᵢ shown in Equation 9, n_{dci}² is the square of the machine count, and S_{brei}² is the sampled variance of the y-intercept bᵣₑᵢ shown in Equation 10.

We know random variables n_{mdi}, m_{dhi}, and n_{fpi} are not Normal distributions. Statistical evaluation of these three random variables indicates they closely match Gamma and Poisson distributions. However, the distribution of the real error nᵣₑᵢ often approximates a Normal distribution, indicating that the CV CAT comes close to meeting the requirements of the Central Limit Theorem for the real error distribution. By assuming normal independent random variables we get a simple, intuitive close-form solution for the variance of the real image count error as shown in Equation 16.

SDEᵢ=Sᵣₑᵢ=\sqrt{Sₘᵣₑᵢ²*n_{dci}²+S_{brei}²} 17)

Equation 17 is the second major error equation in CV CAT. Equation 17 contains the third and fourth coefficients that are updated by the CV CAT in training mode. The final two coefficients are summarized below:

C₃=Sₘᵣₑᵢ 18)

This coefficient is the sampled standard deviation of the slope mᵣₑᵢ defined in Equation 13.

C₄=S_{brei} 19)

This coefficient is the sampled standard deviation of the y-intercept bᵣₑᵢ defined in Equation 14.

We have established two major error equations: 1) the MBE, Equation 11; and 2) the SDE, Equation 17. Together, these error equations have four coefficients: 1) C₁, Equation 13; 2) C₂, Equation 14; 3) C₃, Equation 18; and 4) C₄, Equation 19.

The two major equations MBE and SDE are simple functions of deterministic machine count, and they work in training or non-training mode. The four coefficients are updated in training mode every time the CV CAT receives data corresponding to a labeled image. C₁ and C₂ are sampled means of the slope and y-intercept defined in Equation 9 and Equation 10, while C₃ and C₄ are the corresponding estimates of sample standard deviations of the slope and y-intercept. All four coefficients only use two random variables, m_{dhi} (ratio of missed detection to ground truth count), and n_{fpi} (number of false positives).

Calculating the Percent Random Error

We can approximate the distribution of the real error to be a Normal distribution, and we can estimate its mean and standard deviation by calculating the mean and standard deviation of our sample, which gives us the MBE and SDE.

We quantify the effect of a limited number of samples by using at distribution. The critical value (t_{0.9,v}) from the t distribution is approximately the number of t distribution standard deviations relative to the mean needed to achieve a given uncertainty with a given degree of freedom (v). We note that its use ensures that we always need to multiply the SDE by a number greater than 1.645. We add the critical value of the t distribution factor to the SDE to better estimate the random error with the following equation:

(random error)ⱼ=t_{0.9,v}*SDEⱼ*cf₃, 20)

where t_{0.9,v} is the critical value of the t distribution for a 90-percent confidence level with degrees of freedom v. Note that Equation 20 includes a calibration factor cf₃=0.95, which addresses the issue that the random error is not a perfect t distribution. The degrees of freedom v is given by:

v=nₛₛ−1 21)

A t distribution follows from a random sampling of a standard Normal distribution. We note that when the degrees of freedom approach infinity, the t distribution approaches a Normal distribution. Data obtained during testing indicates that the distribution of the real error, nᵣₑᵢ often approximates a Normal distribution well. This approximation of a Normal distribution justifies the use of a t distribution in our estimate of random error shown in Equation 20.

Quantifying MOE of the MBE

The CV CAT estimates the real error for a given level of confidence. We estimate the real error with the MBEᵢ and SDEᵢ. However, we want to know how close our MBEᵢ is to the mean of the real error. This is determined by the sample size and our confidence interval. A confidence interval is the probability, based on a set of measurements, that the actual value of an event resides within a specified interval. The size of this interval is referred to as the margin of error, or MOE. In this case, the confidence interval (which we choose to specify at the 90 percent level) will give the interval over which the actual real error is 90 percent probable to lie within the MOE on the MBE.

Similarly to the random error, the MOE depends on the sample size, where the MOE will decrease as a larger sample is obtained. In other words, the range of possible values that lie in the 90% confidence interval will narrow as more data are collected. We quantify the relationship between confidence interval and sample size, once again, using a t distribution.

With the t distribution for v degrees of freedom and sample standard deviation of the real error, Sᵣₑⱼ, we can calculate the MOE for the MBE on the j^{th} image to be:

$${MOE}_{mbej} = {t}_{0.9 , v} * \frac{{s}_{rej}}{\sqrt{{n}_{ss}}} \qquad 22 )$$

The sampled standard deviation Sᵣₑⱼ can be estimated by the SDEⱼ.

Sᵣₑⱼ≈SDEⱼ 23)

where the sampled mean of the real error is estimated by MBEⱼ shown in Equation 11.

n [symbol] ≈MBEⱼ 24)

Combining Both Uncertainties

We have just discussed two separate sources of uncertainty in the CV CAT: the random error and the MOE on the MBE. The CV CAT reports a single count and a single uncertainty, where it has represented both sources of uncertainty within one value, the Statistically Adjusted Random Error (SARE). This is done simply by adding the random error and MOE in quadrature, as shown in Equation 25 below:

SAREⱼ=\sqrt{(random error)ⱼ²+MOE_{mbej}²}=t_{0.9,v}*SDEⱼ*cf₃\sqrt{1+(1/nₛₛ)} 25)

We note that, as nₛₛ grows large, the MOE term in the SAREⱼ equation becomes insignificant, and SARE≈random error. In practice, the MOE falls off rapidly as the number of labeled images increases.

We combine the adjusted random error in Equation 25 with the statically adjusted machine count in Equation 15 and create the count uncertainty interval (CUI) shown below:

CUIⱼ=SAMCj±SAREⱼ 26)

Status Signal

The CV CAT also has a binary output called the status signal (SSIG). When the SSIG is high, the CV CAT is producing stable uncertainty calculations. The SSIG will turn to low if any of the three assumptions are violated. The SSIG changes state when the CV CAT is in training mode.

To create the SSIG, we created two CV CAT status metrics. The first status metric (STAT_{MET1}) is the ratio of C₃ to C₁ passed through an exponential moving average (EMA) filter. More formally, we define the first metric as:

$${STAT}_{MET 1 j} = {EMA}_{j} ( \frac{{c}_{3 j}}{{c}_{1 j}} ) , \qquad 27 )$$

where EMAⱼ( ) represents the EMA filter shown below in Equation 31. Our rationale for STAT_{MET1j} is that both C₁ⱼ and C₃ⱼ strongly affect the performance of CV CAT and are sensitive to the ratio of n_{mdi} to n_{hci}. This makes STAT_{MET1j} sensitive to the requirements of Assumption 1.

The second status metric (STAT_{MET2j}) is the ratio of the sampled standard deviation of the false positives to the sample mean of the false positives averaged with an EMA filter, which monitors the major requirement of Assumption 2:

$${STAT}_{MET 2 j} = {EMA}_{j} ( \frac{{s}_{fpj}}{{\tilde{n}}_{fpj}} ) \qquad 28 )$$

The SSIG evaluates STAT_{MET1j} and STAT_{MET2j}. If either metric exceeds a value of around four, the SSIG signal is brought low. If both metrics fall below a value of four, the SSIG is driven high.

Adjustments to Coefficient 1 and Coefficient 3

Based on extensive testing, we observed that both C₁ and C₃ terms slightly overestimate MBE and SDE. These overestimates were proportional to machine count for n_{dc}≥7, and we found that the overestimates increased substantially for n_{dc}<5.

We found that the overestimation of the MBE and SDE are due to two issues. The first issue is the fact that both the false positives and missed detections are not Normal random variables. The second issue is the non-linear truncation effects of using integer numbers as inputs, especially at low real error counts. When the real error becomes small, the number of effective bins in the distribution also becomes small. This distorts the probability distributions of the false positives and missed detections. This truncation effect, especially on low real error counts, creates an asymmetrical distribution for the false positives and missed detections.

To compensate for non-Normal distributions and for truncation effects, we added cubic spline curve fit correction factors to coefficient C₁ and coefficient C₃. Correction factor cf₁ is multiplied by C₁ and correction factor cf₂ is multiplied by C₃. These correction factors were created with a cubic spline and tested over a broad range of m_{dhi} (0.35 to 0.14) and abroad range of n_{dci} (1 to 190). These correction factors are very robust and are valid over a wide range on independent variables.

CVT Performance Monitoring

(U) It is not practical to use sample means and sample standard deviations to calculate the four coefficients, C₁-C₄, due to the large number of samples needed to overcome sample size effects. Further, it is not often practical to wait for all the images and then postprocess them. Therefore, we use digital filters to calculate a running average. The four coefficients are calculated with four different digital filters.

The classic running average or cumulative moving average (CMA) filter is shown in Equation 29 below:

$$CMA = y [ i ] = \frac{1}{k + 1} {\sum }_{k = 0}^{k = {n}_{s} - 1} x [ i - k ] \qquad 29 )$$

Here, x is the input random variable and y is the estimated average. The term nₛ is the total number of the present and past samples. The term i is the index of the present sample, and k represents the index of the past samples.

From the perspective of the signal processing, the above equation is much more efficiently implemented as a recursive equation, a difference equation, or an infinite impulse response (IIR) filter. The recursive form of the CMA (RCMA) is shown in Equation 30 below, which uses two sources of data to calculate each new output point y[i], the present input x[i], and the last output y[i−1]:

RCMA=y[i]=(x[i]+(i−1)*y[i−1])/i 30)

The CMA and RCMA produce identical results. In the initial implementation of the CV CAT, we used CMA filters to estimate the means and variances of the four coefficients and other supporting random variables. However, due to the continuous improvement achieved by ongoing training of CVTs, the best performance of most CVTs is typically from the most recently labeled images. So, instead of an RCMA filter, for at least the first two coefficients, we use EMA IIR filters which give more weight to the most recently labeled image. The EMA gives us some control over the frequency response and effective length of the filter relative to the RCMA or CMA. We control the effective length of the EMA filter and its frequency response through its impulse response time parameter T. The difference equation for the EMA is shown below:

EMA=y[i]=αx[i]+(1−α)y[i−1] 31)

The parameter α is a coefficient that represents how fast the weighting factor on images decreases. Its value ranges between 0 and 1. Higher values of α mean that older images are discounted faster. The sample time is defined as T, which represents the time between two consecutive labeled images. The parameter r represents the impulse response of the filter. We are presently setting α=0.17, but other values may be used. The ratio of τ to T represents the number of images in the impulse response. This ratio is defined below:

$$\frac{τ}{T} = \frac{1}{α} - 1 \qquad 32 )$$

With the present a setting, the above ratio is about five images. The above ratio indicates that the filters require about five images to respond to a unity impulse.

We investigated a variety of IIR and finite input response (FIR) filter types and configurations. The EMA appeared to be the simplest filter to do the job, and it matches the problem set. The next most likely candidate filters were the recursive form of the simple moving average (SMA) and the weighted SMA (WSMA). Both the SMA and WSMA enable control of filter width, but the benefit of using them was outweighed by the additional complexity associated with initializing them. Other IIR filters were more complex and did not seem to add any benefit. We elected to not use FIR filters in general because of the extra time delays they needed to fill their taps. The EMA only has one time-delay tap, which helps it to initialize quickly and respond to transients well. However, any of the filters described above may be used in alternative embodiments without departing from the scope of the specification.

We used both EMA and RCMA filters to calculate all four CV CAT coefficients. The first two coefficients C₁ and C₂ required only one filter each. To calculate the sampled standard deviations for C₃ and C₄, we used four filters. However, we reused the first two filters that estimated the means of C₁ and C₂. We took the square root of the variances to get the sampled standard deviations.

Detailed Discussion of Assumptions

Assumption 1: Nominally Constant Ratio of Missed Detections to Ground Truth Counts at an AOI

We define this ratio of missed detections to human counts at the i^{th} image as follows:

$${m}_{dhi} = \frac{{n}_{mdi}}{{n}_{hci}} \qquad 33 )$$

(U) An equal but alternative description of Assumption 1 is that the Recall at a given AOI is relatively constant. Recall is defined below:

$$R = \frac{{n}_{dci} - {n}_{fpi}}{{n}_{hci}} \qquad 34 )$$

The relationship between Recall and the ratio of the missed detection to human counts is shown below:

$${R}_{i} = 1 - \frac{{n}_{mdi}}{{n}_{hci}} = 1 - {m}_{dhi} \qquad 35 )$$

The sample mean and sample standard deviation of this ratio are both defined as follows:

$$\begin{matrix}{\hat{m}}_{dh} = \frac{1}{{n}_{s}} {\sum }_{i = 1}^{i = n s} {m}_{dhi} & 36 ) \\ {S}_{mdh} = \sqrt{\frac{1}{( {n}_{s} - 1 )} {\sum }_{i = 1}^{i = {n}_{s}} {( {m}_{dhi} - {\hat{m}}_{dh} )}^{2}} & 37 )\end{matrix}$$

A common metric used to gauge the relative variation in a random variable is the ratio of the sample standard deviation to the sample mean. If we use this metric, we can restate Assumption 1 in more quantifiable terms as follows:

$${R}_{SDM 1} = \frac{{s}_{mdh}}{{\hat{m}}_{dh}} {<}_{∼} 2 \text{:} for 8 \text{-} 22 images \qquad 38 )$$

Testing justifies the value of 2 and the eight to 22 image response time in Equation 38 above.

The CV CAT can handle R_{SDM1} values as high as 3.5:1, but this is not recommended. We conservatively limit the values of R_{SDM1} to 2:1. This is partly due to the effect of R_{SDM1} on the CV CAT status signal algorithm discussed above.

In addition to the methodology discussed above, we experimented with a variety of power-law equations and linear equations. One power-law equation we fitted to a scatterplot early in CV CAT development is shown below:

n_{md}=md≈0.09(n_{hc})^{1.3} 39)

After initial testing, we abandoned power-law equations for simple linear equations. Assuming a power-law relationship greatly increased the complexity of many of the equations and processes used in the CV CAT, and there was no noticeable improvement in performance over a linear curve fit.

We intentionally deviated from classical regression techniques. We forced a fit to a linear equation with a zero y-intercept and used an EMA filter to estimate the slope. The linear equation used in the linear curve fit for the scatterplot data is shown below:

n_{mdi}=m̅_{dh}*n_{hci} 40)

The value of the slope m̅_{dh} was set to 0.84 by the EMA filter. The EMA weights the average toward the most recent images. This matches the characteristics of most CVTs that achieve their best performance near the end of their training. Equation 50 is a monotonically increasing function of n_{hci}, produces a zero n_{mdi} when n_{hci} is zero, and favors the most recent images. Our testing confirmed that, although more traditional regressing curve fit techniques will work, Equation 40 with its EMA-derived slope is a much better curve fit to the real problem set.

Equation 40 is nearly a restatement of Assumption 1. It shows that the ratio of n_{mdi} to n_{hci} is relatively constant over any eight to 20 consecutive images and that R_{SDM1}<2.

Assumption 2: Nominally Constant False Positives at an AOI

Generally stated, our Assumption 2 is the mean of n_{fpi} at an AOI is relatively constant for eight to 22 images and is not a function of the machine count. The reasons for specifying eight to 22 images are the same as for Assumption 1, discussed above.

The number of objects in a single category only weakly affects the n_{fpi} count. Since our error analysis is confined to limited AOIs over a limited time, we are assessing this random variable to be independent of the category object count.

We can estimate the mean and variance of n_{fpi} over the reviewed images independent of object count. The sample mean and variance of n_{fpi} are summarized below:

$$\begin{matrix}{\hat{n}}_{fp} = \frac{1}{{n}_{s}} {\sum }_{i = 1}^{i = {n}_{s}} {n}_{fpi} & 41 ) \\ {s}_{fp}^{2} = \frac{1}{( {n}_{s} - 1 )} {\sum }_{i = 1}^{i = {n}_{s}} {( {n}_{fpi} - {\hat{n}}_{fp} )}^{2} & 42 )\end{matrix}$$

A common metric used to gauge the relative variation in a random variable is the ratio of the sample standard deviation to sample mean. If we use this metric, we can restate Assumption 2 in more quantitative terms as follows:

$${R}_{SDM 2} = \frac{{s}_{fp}}{{\hat{n}}_{fp}} {<}_{∼} 2 \text{:} for 8 \text{-} 22 images \qquad 43 )$$

Testing justifies the value of 2 in Equation 43 above.

The CV CAT can handle R_{SDM2} as high as 2.8:1, but this is not recommended. We conservatively limit the R_{SDM2} to 2:1. This is partly due to the effect of R_{SDM2} on the CV CAT status signal discussed earlier.

Assumption 3: CVT Nominal Counting Error Less than 40 Percent

The third assumption is that, for each labeled image, the CVT must perform its detection and classification process with a nominal counting error of less than 40 percent.

The CV CAT calculates the R, Precision (P), and F1 score for each labeled image processed by the CVT that it is monitoring, using the F1 score to track its performance. P and F1 score are calculated as follows:

$$\begin{matrix}P = \frac{{n}_{dci} - {n}_{fpi}}{{n}_{dci}} & 44 ) \\ F 1 = 2 \frac{R * P}{R + P} & 45 )\end{matrix}$$

In equation form, the third assumption can be stated as follows:

F1≥0.6: for all labeled images Assumption 3:

Consistently low F1 values make it difficult for the four coefficients in the CV CAT's two major error equations to converge to a set of stable values. When Assumption 3 is violated, the CV CAT typically overestimates the count uncertainty. To avoid these problems, the CV CAT filters out data corresponding to labeled images that have F1 values below 0.6 when in training mode. When the CV CAT is processing non-labeled imagery machine counts, compliance with Assumption 3 is not required but recommended. The CV CAT is much more tolerant of poorly performing CVTs when not attempting to train the error coefficients. Despite the CV CAT's tolerance of poorly classified imagery in non-training mode, continuous groups of poorly classified images will cause the CV CAT to overestimate count uncertainties even in non-training mode, especially if they are the most recent group of 8 to 22 images. This can be mitigated by periodically switching the CV CAT to training mode.

(U) In addition to the three assumptions discussed above, there are a few other considerations addressed below that primarily effect ATR tools and CVTs with secondary effects on the CV CAT.

### Other Considerations

Obscuration

For optimal performance, pre or post-processing tools, as known in the art, should be used to identify images in which the AOI is sufficiently obscured to prevent effective functioning of the CVT. Data for images so identified may be removed from the data processed by the CV CAT or may be ignored by the CV CAT during data processing.

(U) Collection Geometry

(U) From our experience with CVTs and multiple sensors, some constraints on extreme collection geometries would aid in achieving optimal performance out of the CVTs. The techniques described above could also be sued to filter collection geometries if the collection angles associated with each labeled image were provided.

Changing CVT Thresholds

Many CVTs use thresholds in some manner. When these thresholds change at a given AOI, they typically impact the n_{fpi} counts and the n_{mdi} counts. These impacts can be mitigated by triggering the CV CAT training mode after a change in one or more CVT thresholds.

Multiple Classifiers

(U) The CV CAT was presented in the context of a single classifier. This does not imply the CV CAT cannot be adapted to multiple classifiers. Vectoring the CV CAT to handle multiple classifications is a relatively simple and straightforward programming problem. Multiple classifiers would not negate the CV CAT's algorithms or processes presented in this section and would not depart from the scope of the specification.

### SAMPLE EMBODIMENTS

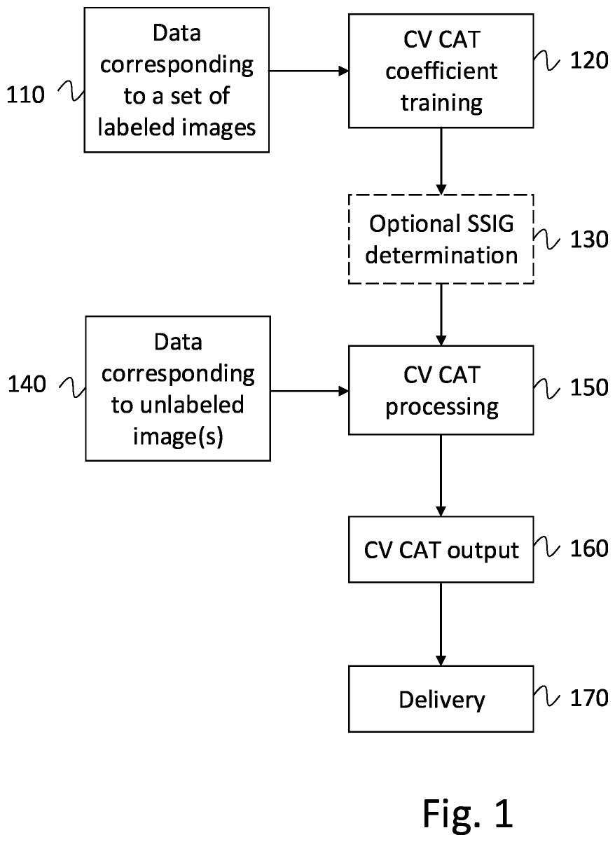

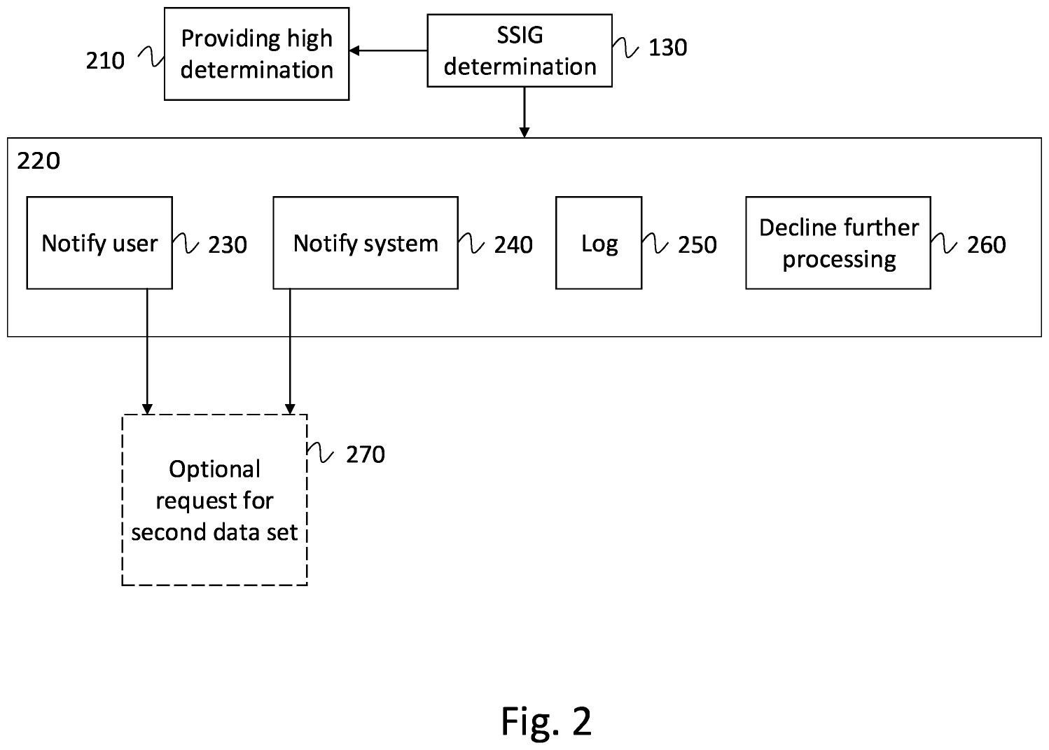

FIG. 1 illustrates one embodiment of the CV CAT. Data 110 corresponding to a set of labeled images is received and used to train 120 the CV CAT coefficients, as described above. Optionally, the SSIG may be determined 130 based on the data 110. The determination 130 is described further in the discussion of FIG. 2. A second set of data 140 corresponding to one or more unlabeled images is received and processed 150 by the CV CAT. Outputs 160 comprising the SAMC and CUI are provided 170 to one or more of: a user; another system; a log; or any other recipient known in the art. Providing 170 the output 160 to a user may be accomplished using any one or more of: a visual display; a printed report; and audible signal; a natural user interface; or any other method known in the art.

FIG. 2 illustrates a process if the optional SSIG determination 130 is made. If the result of the determination 130 is high, the result may be provided 210 to one or more of: a user; another system; a log; or any other recipient known in the art. If the result of the determination 130 is low, the CV CAT may take any one or more of the following actions 220: provide 230 a notification to a user; provide 240 a notification to another system, possibly including the source of the data 110; record 250 the result in a log; decline 260 to process any unlabeled data from the source of data 110; or any other notification or recordation actions known in the art. Any of the notifications 230 or 240 may include a notice of the declination 260 and/or a request for a second set of data 270 corresponding to a set of labeled images different from data 110. If data 270 is received, the steps of FIG. 1 may be repeated with data 270 in lieu of data 110.

In one embodiment, the percent confidence interval to be used by the CV CAT may be modified. To modify the percent confidence interval, a request to modify the percent confidence interval is sent to the CV CAT. The request may be sent manually by a user through a user interface or any method known in the art. Alternatively, the request may be sent automatically based on predetermined static or variable conditions related to CV CAT, the CVT being used as a data source, the AOI, the data being provided to the CV CAT, or any other relevant factor known in the art. Any one or more of the requested percent confidence intervals or data corresponding to a set of labeled images may be provided as part of the request to modify the percent confidence interval, or via a separate input. Where data corresponding to a set of labeled images is provided, the provided data may comprise data that has not been processed by the CV CAT or data that was previously processed by the CV CAT for the same or a different percent confidence interval.

In one embodiment, the CV CAT, or another system in communication with the CV CAT, is arranged to request recalibration of the CV CAT. To request recalibration, a request for data corresponding to a set of labeled images that has not been processed by the CV CAT is provided to one or more of: a user; or a system in communication, directly or indirectly, with the CVT generating the data being processed by the CV CAT. The request may be sent in response to any one or more of: a low SSIG determination; the CV CAT processing data corresponding to a predetermined number of unlabeled images, where the predetermined number may be set by a user or by an automated process; an input from a user; a predetermined amount of time, where the predetermined number may be set by a user or by an automated process; a notification from the CVT providing the data being processed by the CV CAT where the notification may or may not be provided in response to or as part of a change in one or more CVT thresholds; or any other process or criteria known in the art.

In one embodiment, the CV CAT may recalibrate itself in response to one or more of: a request from the CVT generating the data being processed by the CV CAT; or receipt of a set of data corresponding to a set of labeled images.

In one embodiment the CV CAT modifies n_{fpi} to account for one or more images that do not include the entire AOI. The modification is based at least in part on information regarding the percentage of the AOI not included in the image(s) and comprises scaling n_{fpi} up by an amount equal to the percentage of the AOI not included in the image(s).

In one embodiment, the CV CAT, or another system in communication with the CV CAT, may provide a notification to a user or an alert system in response to any one or more of the following: the CV CAT processing data corresponding to a predetermined number of unlabeled images, where the predetermined number may be set by a user or by an automated process; a predetermined amount of time, where the predetermined number may be set by a user or by an automated process; the CUI exceeding a predetermined range, where the predetermined range may be set by a user or by an automated process; the difference between the CUI for data related to a given image and the CUI for data related to a preceding image exceeding a predetermined amount, where the predetermined amount may be set by a user or by an automated process; the SARE exceeding a predetermined value, where the predetermined value may be set by a user or by an automated process and may be static or dynamic; the difference between the SARE for data related to a given image and the SARE for data related to a preceding image exceeding a predetermined value, where the predetermined value may be set by a user or by an automated process and may be static or dynamic; or the difference between the machine count and the SAMC exceeding a predetermined value, where the predetermined value may be set by a user or by an automated process and may be static or dynamic (including dynamic scaling based on the machine count). The notification may include: the reason why the notification was sent; relevant data, including information related to ranges or amounts being exceeded or the CVT generating the data being processed by the CV CAT; instructions for recalibrating the CV CAT; a request for a determination to continue or discontinue processing data; or any other information or requests known in the art.

The embodiments described above may be used in any combination without departing from the scope of the specification, and may be implemented using any form of appropriate computing-based device.

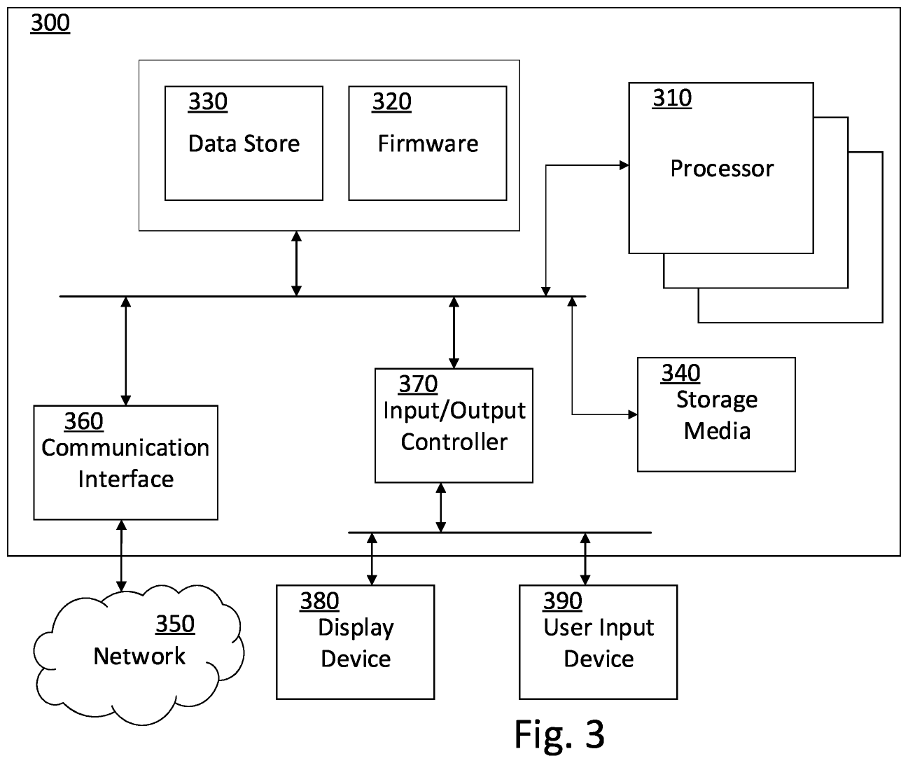

FIG. 3 illustrates various components of an exemplary computing-based device 300 which may be implemented as any form of a computing and/or electronic device, and in which embodiments of a controller may be implemented.

Computing-based device 300 comprises one or more processors 310 which may be microprocessors, controllers or any other suitable type of processors for processing computer executable instructions to control the operation of the device. In some examples, for example where a system on a chip architecture is used, the processors 310 may include one or more fixed function blocks (also referred to as accelerators) which implement a part of controlling one or more embodiments discussed above. Firmware 320 or an operating system or any other suitable platform software may be provided at the computing-based device 300. Data store 330 is available to store sensor data, parameters, logging regimes, and other data.

The computer executable instructions may be provided using any computer-readable media that is accessible by computing based device 300. Computer-readable media may include, for example, computer storage media such as memory 340 and communications media. Computer storage media, such as memory 340, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but signals per se, propagated or otherwise, are not examples of computer storage media. Although the computer storage media (memory 340) is shown within the computing-based device 300 it will be appreciated that the storage may be distributed or located remotely and accessed via a network 350 or other communication link (e.g. using communication interface 360).

The computing-based device 300 also comprises an input/output controller 370 arranged to output display information to a display device 380 which may be separate from or integral to the computing-based device 300. The display information may provide a graphical user interface. The input/output controller 370 is also arranged to receive and process input from one or more devices, such as a user input device 390 (e.g. a mouse, keyboard, camera, microphone, or other sensor). In some examples the user input device 390 may detect voice input, user gestures or other user actions and may provide a natural user interface. This user input may be used to change parameter settings, view logged data, access control data from the device such as battery status and for other control of the device. In an embodiment the display device 380 may also act as the user input device 390 if it is a touch sensitive display device. The input/output controller 370 may also output data to devices other than the display device, e.g. a locally connected or network-accessible printing device. The input/output controller 370 may also connect to various sensors discussed above, and may connect to these sensors directly or through the network 350.

The input/output controller 370, display device 380 and optionally the user input device 390 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments and/or combine any number of the disclosed embodiments without departing from the spirit or scope of this specification.

1. A method for generating a statistically adjusted machine count for an object of interest, the method comprising:
receiving, for each of a plurality of first images analyzed by a computer vision tool:
a number of objects in the image;
a number of false positives; and
a number of missed detections;
determining, for each of the plurality of images, a real error in the number of objects counted by the computer vision tool;
generating, based on the plurality of real error values, a first coefficient and a second coefficient;
receiving a number of objects counted by the computer vision tool for one or more second images;
determining a statistically adjusted machine count for the one or more second images, where the statistically adjusted machine count is based at least in part on the first coefficient, second coefficient, and the number of objects counted by the computer vision tool for the one or more second images.

2. The method of claim 1 further comprising determining a mean bias error, where the mean bias error is a function of sample means derived from the real error values.

3. The method of claim 1, wherein the number of missed detections is modeled as a linear function.

4. The method of claim 1, wherein the plurality of real error values is modeled as a linear function.

5. The method of claim 4, wherein the first coefficient is the sampled mean of the slope of the linear function.

6. The method of claim 4, wherein the second coefficient is the sampled mean of the intercept of the linear function.

7. A method for generating a statistically adjusted random error, the method comprising:
receiving, for each of a plurality of first images analyzed by a computer vision tool:
a number of objects in the image;
a number of false positives; and
a number of missed detections;
determining, for each of the plurality of images, a real error in the number of objects counted by the computer vision tool;
generating, based on the plurality of real error values, a third coefficient and a fourth coefficient;
receiving a number of objects counted by the computer vision tool for one or more second images;
determining a statistically adjusted random error for the one or more second images, where the statistically adjusted random error is based at least in part on the third coefficient, fourth coefficient, and the number of objects counted by the computer vision tool for the one or more second images.

8. The method of claim 7, wherein the plurality of real error values is modeled as a linear function.

9. The method of claim 8, wherein the third coefficient is the sampled standard deviation of the slope of the linear function.

10. The method of claim 8, wherein the second coefficient is the sampled standard deviation of the intercept of the linear function.

11. The method of claim 8 further comprising determining an estimate of random error, where the estimate of random error is a function of the sampled variance of the slope of the linear function and the sampled variance of the intercept of the linear function.

12. The method of claim 8 further comprising determining a margin of error of a mean bias error, where the mean bias error is a function of sample means derived from the plurality of real error values and the margin of error is based at least in part on a sample standard deviation of the plurality of real error values.

13. The method of claim 12, wherein the margin of error is further based at least in part on a predetermined confidence interval.

14. The method of claim 7, wherein the plurality of real error values is approximated as a normal distribution.

15. The method of claim 7 further comprising, in response to the statistically adjusted random error exceeding a threshold, sending a notification to at least one of a user or system.

16. A method of generating a status signal, the method comprising:
receiving, for each of a plurality of first images analyzed by a computer vision tool:
a number of objects in the image;
a number of false positives; and
a number of missed detections;
determining, for each of the plurality of images, a real error in the number of objects counted by the computer vision tool;
generating, based on the plurality of real error values, a third coefficient and a first coefficient;
generating a first status metric, the first status metric based at least in part on a ratio of the third coefficient and the first coefficient;
generating, for each of the plurality of first images, a second status metric, the second status metric based at least in part on a ratio of a sampled standard deviation of the false positives to the sample mean of the false positives;
determining, for each of the first and second status metrics, whether the status metric exceeds a threshold value.

17. The method of claim 16, wherein the plurality of real error values is modeled as a linear function.

18. The method of claim 17, wherein the third coefficient is the sampled standard deviation of the slope of the linear function.

19. The method of claim 17, wherein the first coefficient is the sampled mean of the slope of the linear function.

20. The method of claim 16, wherein the first and second status metrics are further based at least in part on an exponential moving average infinite impulse response filter.
